(19) United States
(12) Patent Application Publication
(10) Pub. No.: US 2012/0254749 A1
(43) Pub. Date: Oct. 4, 2012

(54) System And Method For Controlling Life Goals

(75) Inventors: J. Hunter Downs, III, Honolulu, HI (US); Traci H. Downs, Honolulu, HI (US); Robert Matthews, San Diego, CA (US); J Patrick Stautzenberger, Haleiwa, HI (US); Kevin J. Talbot, Kaaawa, HI (US)

(73) Assignee: ARCHINOETICS, LLC, Honolulu, HI (US)

(21) Appl. No.: 13/434,379

(22) Filed: Mar. 29, 2012

Related U.S. Application Data
(60) Provisional application No. 61/469,083, filed on Mar. 29, 2011.

(51) Int. Cl. G06F 3/048

(52) U.S. Cl. 715/706

(57) ABSTRACT

A method and system for assisting a user in achieving a goal are described. Input related to the goal is received from the user. The input includes body sensor data from a body sensor worn by the user, a photograph of the user and/or an avatar configured by the user. Data related to the goal is mined from at least one external source. The user is provided with at least one recommendation for achieving the goal based on the input from the user and the mined data.

### CROSS-REFERENCE TO RELATED APPLICATIONS

This application claims the benefit of provisional Patent Application Ser. No. 61/469,083, filed Mar. 29, 2011, assigned to the assignee of the present application, and incorporated herein by reference.

### BACKGROUND

As information technology has advanced, increasing amounts of information have become available on virtually any topic of interest. The result for end users has been information overload. Users are faced with too much information to be able to digest and use. Even if a user searches only information on particular topics, the result is often not presented in a meaningful manner and still includes too much data for a user to understand. Even obtaining useful information on everyday goals, such as saying fit or managing ones finances may be challenging.

Accordingly, what is needed is an improved mechanism for obtaining, presenting, and utilizing information on topics of interest.

### BRIEF SUMMARY OF THE INVENTION

A method and system for assisting a user in achieving a goal are described. Input related to the goal is received from the user. The input includes body sensor data from a body sensor worn by the user, a photograph of the user and/or an avatar configured by the user. Data related to the goal is mined from at least one external source. The user is provided with at least one recommendation for achieving the goal based on the input from the user and the mined data.

### BRIEF DESCRIPTION OF THE DRAWINGS

FIG. 1 is a logical block diagram illustrating an exemplary embodiment of a system for obtaining and presenting information to users.

FIG. 2 is an exemplary embodiment of a pod in a watch format.

FIG. 3 is an exemplary embodiment of a computer system/hub in a home.

FIG. 4 is a flow chart illustrating an exemplary embodiment of a method for obtaining and presenting information to users.

FIG. 5 is a diagram illustrating an exemplary embodiment of an introductory user interface for the system.

FIG. 6 is a diagram illustrating an exemplary embodiment of positive graphical feedback for the system.

FIG. 7 is a diagram illustrating an exemplary embodiment of negative graphical feedback for the system.

### DETAILED DESCRIPTION OF THE EMBODIMENTS OF THE INVENTION

The present invention relates to methods and systems for assisting people in achieving their goals through mining of information, processing and presenting relevant information to the users in a useful manner, and motivating users to achieve their goals. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

As will be appreciated by one of ordinary skill in the art, aspects of the present invention may be embodied as a system, method or computer program product. Accordingly, aspects of the present invention may take the form of entirely in hardware, entirely in software (including firmware, resident software, micro-code, etc.) or in combination of software and hardware that may all generally be referred to herein as, for example a “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Some specific examples include but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, another medium, or some combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The exemplary embodiments provide methods and systems are designed to assist users in outlining their life goals in a simplified graphical manner and then manage the overwhelming amount of information available to the user. The information may include information from sensors in addition to information from the Internet and other analogous sources. The system and method simplify the information down to simple metrics and present this information in a meaningful graphical manner in such a way to keep the person motivated to their goal. The motivation may include both positive and negative feedback. The system will be built around adaptive intelligent algorithms that will mine the available data, detect trends and make recommendations. Because the algorithms are adaptive, the filtering of data, recommendations provided, and other responses by and activities of the system improve over time.

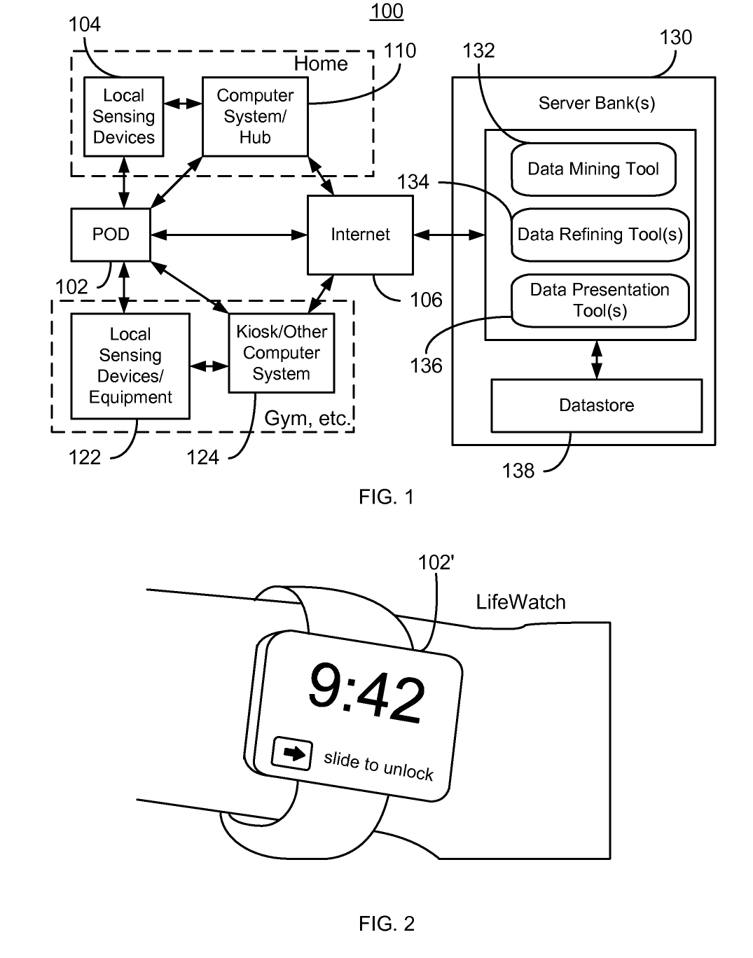

FIG. 1 is a block diagram illustrating an exemplary embodiment of a system 100 for assisting people in achieving their goals. More specifically, the system may be used to mine information from the internet, sensors and other sources; filter, prioritize and reduce the data set; determine recommendations and/or feedback/motivation; and present the data to the user in a personalized format. The system may thus assist a user in identifying, providing information relating to, providing motivation and feedback for, and achieving the user's goals. The goals may be in a variety of areas including but not limited to health, finance, social, career, and entertainment. For example, the health goals might include fitness goals such as the time for completing a particular event (such as a given hike or run), muscle size, weight, percent of body fat, volume of oxygen (VO2) max, lactate threshold, specific skills for a sport, distance or performance for a particular sport, recovery time, preparation for an activity/trip/event, and/or activity level. Health goals may also relate to issues such as nutrition, disease risk factor reduction (e.g. a reduction in risk for diabetes or coronary disease), sleep, calories (intake and/or burning), stress, diet, jet lab, smoking, drinking, lethargy, bad breath, teeth/gums, mental health, tracking environmental factors correlating with certain concerns, migraines, and/or identifying risks for common diseases or sicknesses. Financial goals may include income, investments, bill reduction, retirement planning, debt reduction, budgeting, coupons, savings, insurance, wills/trusts, holidays, and/or college funds. Social goals might include group activities, keeping in touch with friends (distant or otherwise), finding new friends, hobbies/activities for example in the user's geographic area, and/or tracking particular life events of friends and family. Career goals may include salary, position, title, job searches, new skills, career changes, and mentoring. Entertainment activities might include movies, books, theater, music, shopping, television, magazines, news, and/or other social activities of interest. Further, the goals may relate to other categories of interest.

The system includes POD(s) 102, local sensing devices 104 connected to a computer system/hub 110, another set of local sensing devices/equipment 122, a kiosk or other computer system (“kiosk”) 124 and server bank 130. Although only one of each component is shown, the system 100 may include multiples of one or more of the components. The pod(s) 102 and other devices are shown as communicating with the server via the Internet 106. However, in other embodiments, the pod(s) 102 and other devices shown may communicate directly with the server 130, for example via wireless communication. Further, certain components, such the computer system/hub 110, are shown as communicating with a subset of the remaining components. In another embodiment, the remaining components may communicate directly.

The server bank(s) 130 may include multiple servers and utilize one or more datastore(s). The server bank includes data mining tool(s) 132, data refining tool(s) 134, and data presentation tool(s) 136. Although shown as residing in the server bank 130, some portion or all of each of these tools 132, 134, and/or 136 may reside in other components of the system 100. Further, the functions of these tool modules 132, 134, and/or 136 may be combined into fewer modules or expanded into additional modules. The data mining tool(s) 132 obtain data from various sources. The data mining tool(s) 132 may mine various sources (not shown) on the Internet 106. For financial goals, for example, the data mining tool(s) 132 might take data from credit card suites, banks, 401k/investment tracking, Craigslist, eBay, online newspapers, experts, or phones or voice sources. The data mining tool(s) 132 might also obtain data from sensors, for example, from local sensing devices and equipment (described below). For fitness/health goals, such data might include information relating to the muscle state for the user, cardio state of the user, weight, activity level, number of steps taken, calories burnt, or hydration level. Data refining tool(s) 134 may be used to sort through the data obtain by the data mining tool(s) 134 to process and select the information presented to the user. The data refining tool(s) 134 may also filter the data obtained by the data mining tool. Thus, the reduced set of information to be presented to the user is selected to improve the user's ability to apply the information. The data refining tool(s) 134 may, for example, determine suggestions for meeting the user's goals based not only on information gleaned from the internet or other sources, but also from the sensors and the user's own preferences. These suggestions may include positive or negative images, text, audio, video or other mechanisms for conveying information. The data presentation tool(s) may be used provide the appropriate portion of the filtered information to the user. Further the data presentation tool(s) 136 may provide the information to the user that improves the user's motivation. For example, the data presentation tool(s) 136 may select audio, video, pictures, an indication of the user's progression toward a particular goal, reflect progression away from a particular goal, or other motivational information. The data presented may thus inspire the user to continue particular behavior changes made to advance their goals.

The pod(s) 102 are portable devices that may be capable of sensing information; uploading the information to the computer system/hub 110, kiosk 124, and/or server bank 130; and receiving information from other portions of the system 100. The pod(s) 102 may be easily transportable, moveable computer system that may, for example, fit in a watch or other wearable system. In general, the pod(s) 102 are desired to travel with the user to various locations. Further, the pod(s) 102 may include at least some of the functions in/analogous to the local sensing devices 104. For example, the pods 102 may include a watch 102′, depicted in FIG. 2. In addition, such a pod 102 may be/include a removable module that can connect to devices of the system 100 to upload or download information. For example, a wireless scale might upload to the pod 102 a user's weight, while the pod 102 might download to the computer system/hub 110 the user's level of activity. Functional modules in the pod 102 might include an MP3 player and actigraphy/sleep analyzer, a mechanism for measuring heat flux, temperature, and/or other sensors. Such a pod 102 may be rechargeable, for example through inductive charging, but is generally desired to maintain a charge for months. The pod 102 may also wirelessly connect to the computer system/hub 110 and local sensing devices 104. The pod 102 may also be removable from the watch 102′, for example to be carried in a purse, clipped to a belt or otherwise kept available. Thus, a user may continue to work on and receive feedback related to their goals regardless of their location.

The local sensing devices 104 residing at home may include items such as a scale. However, other items may also be used as local sensing devices 104 for various goals. For example, toothbrushes, medication containers, dental floss, home exercise equipment, or other devices. Note that devices such as toothbrushes, medication containers and dental flosses may have an RFID or other tag that is used as the sensor. Such sensors may provide an indication of whether such devices are used. Further, these devices communicate, for example wirelessly, with the computer system/hub 110. In some embodiments, these devices may also communicate directly with the pod 111.

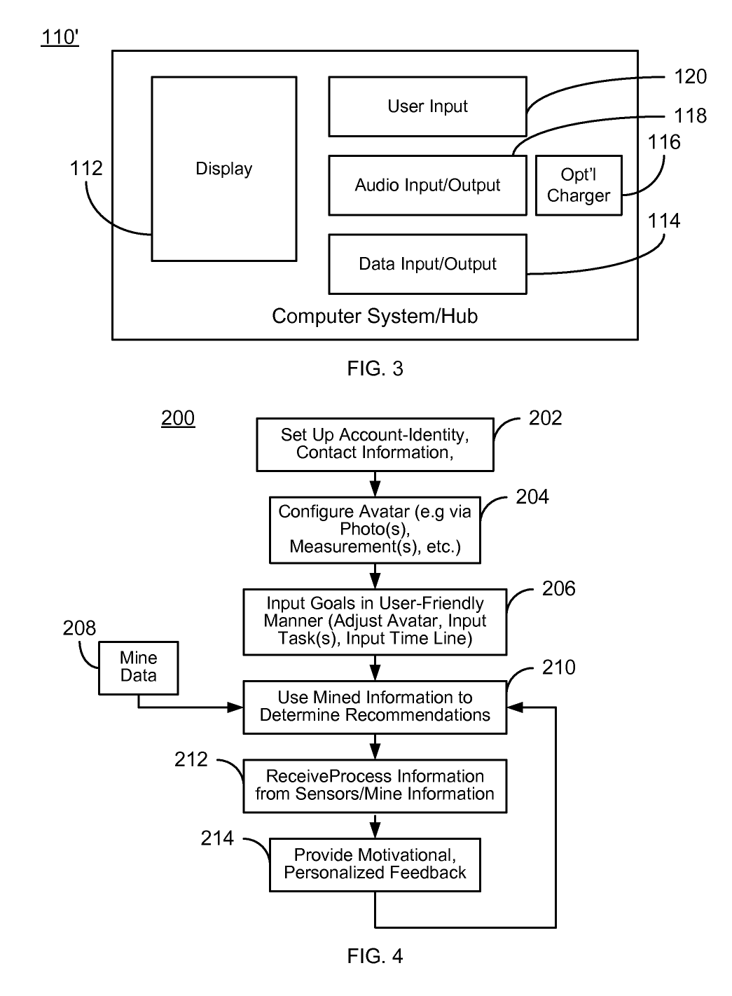

The computer system/hub 110 communicates with the pod 102 and local sensing devices 104 and 122 to obtain data and provide feedback. FIG. 3 is a block diagram of an exemplary embodiment of a computer system/hub 110′. Thus, the computer system/hub 110′ includes a display 112 for depicting static, video, and/or other data, audio input/output 118 such as a microphone and speakers, data input/output 114 such as a wireless connection, and a mechanism for accepting user input 120. For example, a keyboard and mouse might be used to allow the user to provide input. An optional charger 116 for the pod(s) 110 might also be included. The computer system/hub 110/110′ also communicates with the server bank 130 to obtain information and/or upload data from the local sensing devices 104/122, pod 110 and/or itself. For example, a scale (local sensing device) might provide a current weight to the computer system. The computer system 110/110′ may compare that to data for the user stored internally or at the server bank 130. Based on the comparison, the computer system 110/110′ may receive from the server bank 130 a response or recommendation. The pod 102/102′ might be updated via the Internet 106 or computer system/hub 110/110′ with recommendations, motivational material or other information. Further, the user may access the server bank(s) 130 and be provided with recommendations, feedback, and/or other via the computer system/hub 110/101′. The user may also access and configure their account, select and update goals, and perform other tasks.

The local sensing devices/equipment 122 and kiosk 124 at the gym are analogous to the local sensing devices 104 and computer system/hub. Local sensing devices/equipment 122 at the gym might include exercise equipment, scales, weightlifting equipment, vitamin or water containers, a mechanism for measuring hydration, and/or other devices. Such local sensing devices 122 and kiosk/other computer system 124 operate in conjunction with the pod 102/102′, internet 106 and server bank 130 in an analogous manner to the systems at home. Because the user carries the pod 102/102′ with them to the gym, the user may be updated more frequently with information in a manner that is useful in meeting their life goals. Analogous equipment may be included other locations. For example, such local sensing devices/equipment at a supermarket or restaurant might analyze the quality of food—it's sweetness or freshness for example via vapor or infrared measurements). Such equipment at a drug store, hospital, or home might analyze blood glucose or provide a breath analyzer. This information may be uploaded to the server bank(s) and/or provided to the pod.

FIG. 4 is a flow chart illustrating an exemplary embodiment of a method 200 for using the system. The method is described in the context of fitness goals. However, the method 200 may be extended to other goals including but not limited to social/entertainment, financial, nutritional, and/or other goals. The method 200 is described in the context of particular steps performed in a certain order. However, the steps may be performed in another order (including simultaneously), omitted, and/or combined. The method is generally desired to be performed in connection with the system 100 depicted in FIGS. 1-3. However, in other embodiments, the method 200 might utilize other systems.

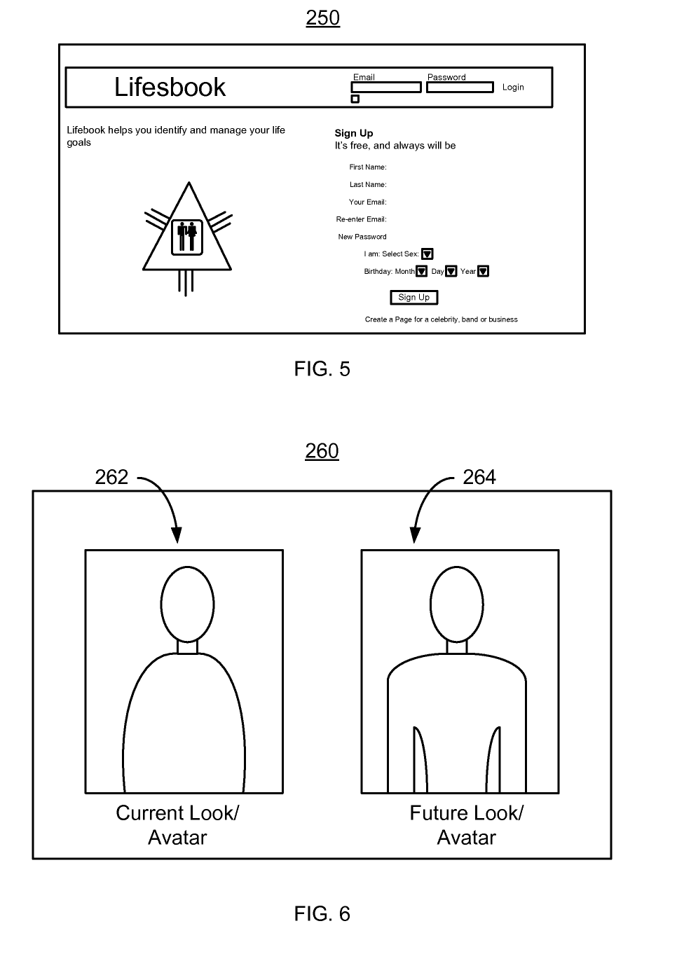

The user might initially access the system/server bank(s) 130 from the kiosk 124 or computer system/hub. For example, FIG. 5 depicts an exemplary embodiment of an introductory screen 250 for the user interface that may be provided on the display. The display indicates the system being used. Once reaching this screen, the user may start by configuring an account, via step 202. This may include providing identifying information such as a name, email address(es), password(s), gender, age/birth date, preferences, and other information. In some embodiments, the method 200 and system 100 may be free, but in other embodiments, there may be a charge. In such embodiments, payment may also be arranged as part of configuring the account.

The user also configures an avatar, via step 204. This may include inputting photo(s) of the user, providing measurements, weight, selecting hair or eye color or performing other tasks that personalize the avatar, and/or taking measurements (e.g. using local devices to provide weight, height or other data). The user may be requested to fill out a survey. Additional data for the user may be generated based on statistics related to categories in which the user may fit, on and/or off body sensor(s), camera images, physiologic signals, and/or environmental sensors. In some embodiments, for example in which the user may select features of the avatar, the avatar may represent an idealized version of the user. However, in general, a more accurate representation of the user is desired.

The user's goal(s) are then input in a user-friendly manner, via step 206. The user may identify and select goals from goals or categories provided by the system. In some embodiments, the system may lead the user through various options, in a manner analogous to a wizard, to assist the user in identifying goals. For example, the user may select from “Health”, “Entertainment” and “Finance” categories. If “Health” is selected, the user may select from “Fitness” and “Nutrition”. Under “Fitness” the user might select from various subcategories such as “Sports”, “Cardiovascular”, “Performance” and “Appearance/Weight”. The user may continue to be led through various options until a goal is settled upon and entered. Alternatively, the user may simply enter a goal such as “fitting into a size 2 dress”, “finishing a marathon”, “losing 10 pounds”, “having better looking nails”, “improving the look of my teeth, hair, skin, etc.”, setting a desired perceived age, or other goal. Other performance related goals might include the time to run an event, size of a muscle, amount of weight you can move, distance you can hit a ball, how far you can run, VO2max, Lactate threshold, improved performance for a specific sport, recovery time after an event, preparation for an activity like a long hike or other activity. For appearance related goals, the user may also be able to input the goal by adjusting the appearance of their avatar. For example, waist size might be decreased, overall weight reduced, muscle size increased, or other options. This may be achieved though sliding bars that change the appearance of various portions of the avatar or entering metrics for portions of the avatar. Alternatively, the goal might be selected by the user choosing an image from a database. The system may also allow the user to define aspects of their nails, hair, skin, teeth, or other feature. The timeline for the goal may also be entered. For example, the user may indicate that the goal is desired to be achieved in a week, a month, a year, or another time. Alternatively, the time frame maybe simply “short”, “medium”, or “long” term.

The system mines data from sensors, the Internet and/or other sources, via step 208. This data is used in conjunction with the goals and other aspects of the user's profile to determine recommendations for the user to achieve their goals, via step 210. For example, the user's goal may to reduce their clothing size in a month. If the user's profile indicates they are not a gym goer, the system might recommend that the user take a daily walk. If the user's profile indicates that the user does belong to a gym, the system may recommend a particular workout. Based on the goals, other recommendations such as taking vitamins for skin or nails, changes in diet, or changes in other habits may be recommended.

As time goes on, information may be received from the sensors in the system, via step 212. These sensors may be in the pod(s), the local sensing devices at home, the local sensing devices at the gym or other locations. Thus, the user's level of activity, weight, use of various pieces of equipment, or other relevant actions may be indicated. Additional information may also be mined in step 212. Feedback may then be provided to the user, via step 214. For example, the watch containing the pod may be updated with an indication of how far the user is progressing in their goal or a sub-goal identified by the user or the system. In addition, the system 100 may accept input from the user related to the recommendations or other interaction with the user.

The system 100 may also interact with the user based on other data and learn from this interaction. For example, the system 100 may indicate to the user (via the pod 102/102′) that the user is currently using a treadmill based on actigraphy data from the watch pod 102′. The user may provide a correction via the pod 102/102′, indicating that the user is on a rower. The system 100 may learn the user's habits such that the system 100 provides better recommendations, better guesses as to the user's activities, and feedback better suited to the particular user.

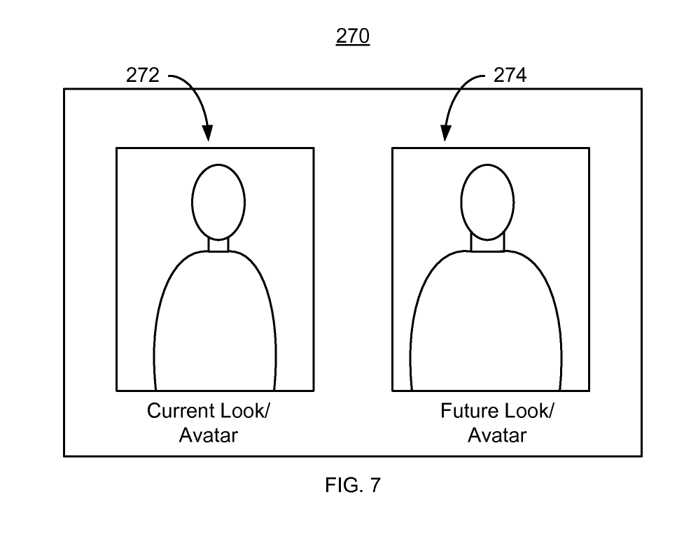

Feedback may also be provided on the display of the computer system/hub and/or kiosk. For example, FIG. 6 depicts an exemplary embodiment of positive graphical feedback 260 for the system 100. The user's current avatar 262 may be compared with an expected future appearance 264 if the user maintains their current behavior/adherence to their recommendations. Although FIG. 6 depicts the current and future views together, in other embodiments, they may be shown separately. Conversely, FIG. 7 depicts an exemplary embodiment of negative graphical feedback 270 for the system 100. Again, the user's current look or avatar 272 is compared to their expected future appearance 274 if the user maintains their current behavior/failure to follow to the recommendations. Although FIG. 7 depicts the current and future views together, in other embodiments, they may be shown separately. Feedback may also be provided in another manner suited to the user. For example, audio, text, video, or other feedback mechanisms may be used. The mining of information, receiving and processing of information, and providing feedback continues as the user progresses toward his or her goal. Further, the user may update his or her goals. Thus, the user may add, remove, or change their goals. The system updates the information to provide updated recommendations and personalized feedback.

Thus, the system 100 uses a combination of data collected from the subject, mined data, sensors on and off the subject and expert advice to provide recommendations and/or motivational feedback. Thus, the system and method may help users progress toward their life goals in the desired time frame.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code that implements the specified function(s). Although shown in a particular order, various steps/blocks may be interleaved, omitted, combined, performed in another order, and/or executed substantially concurrently.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the method and system.

We claim:

1. A computer-implemented method for assisting a user in achieving a goal, the method performed by at least one software component executing on at least one processor and comprising:
receive input from the user, the input being related to the goal and including at least one of body sensor data from a body sensor worn by the user, a photograph of the user and an avatar configured by the user;
mining data from at least one external source related to the goal; and
providing the user with at least one recommendation for achieving the goal based on the input and the data.

2. The computer-implemented method of claim 1 further comprising:
determining a progression of the user toward the goal; and
providing feedback based on the progression and the input from the user.
